(19) United States
(12) Patent Application Publication
(10) Pub. No.: US 2008/0217493 A1
(43) Pub. Date: Sep. 11, 2008

(54) SUCTION CUP FOR ROUGH SURFACES

(75) Inventor: JoeBen BEVIRT, Santa Cruz, CA (US)

Correspondence Address: Beyer Law Group LLP, P.O. BOX 1687, Cupertino, CA, 95015-1687, US

(73) Assignee: JOBY INTERNATIONAL SARL, Geneve (CH)

(21) Appl. No.: 12/058,519

(22) Filed: Mar. 28, 2008

Related U.S. Application Data
(63) Continuation-in-part of application No. 11/637,611, filed on Dec. 12, 2006.
Application No. 11/637,611 is a continuation-in-part of application No. 11/324,994, filed on Jan. 3, 2006.

(51) Int. Cl. F16B 47/00; F16M 11/22

(52) U.S. Cl. 248/163.1; 248/206.1

(57) ABSTRACT

A suction cup adapted to couple objects to rough surfaces includes a flexible sealing member, a backing member and a release mechanism. The sealing member is placed flush against a rough surface to form a low pressure region therebetween. The backing member is coupled to the sealing member and pulls a central portion of the sealing member away from the rough surface to create a suction hold. The release mechanism diminishes this suction hold when activated by a user. The sealing member material has a durometer rating of less than about 50, shore A. A rigid outer shell disposed above the sealing and backing members includes a rim to facilitate seal creation between the sealing member and the rough surface, and houses a portion of the release mechanism, which can include a button or lever adapted to push or pull the backing member toward or away from the rough surface.

### CROSS-REFERENCE TO RELATED APPLICATIONS

This application is a continuation-in-part of and claims priority to co-pending U.S. patent application Ser. No. 11/637,611 by Bevirt et al., entitled “Accessory Clips and Mounting Apparatus Using Same,” filed Dec. 12, 2006, which in turn is a continuation-in-part of and claims priority to U.S. patent application Ser. No. 11/324,994 by Bevirt, entitled “Ball and Socket Joint with Gripping Features and Smooth Motion and Apparatus Using Same,” filed Jan. 3, 2006, both of which are incorporated by reference herein in their entireties and for all purposes.

### TECHNICAL FIELD

The present invention relates generally to fastening devices, and more particularly to the use of suction cups adapted to couple objects to various surfaces.

### BACKGROUND

Mounting devices may come in a variety of forms. Some mounting devices are used to mount various types of hardware or objects to a variety of types of structure. Suction cups are one traditional way of quickly and conveniently mounting, attaching or otherwise coupling objects to smooth surfaces, such as glass. Suction cups are typically made of rubber, plastic or some other flexible yet resilient material, and are usually designed such that a vacuum or other low pressure region between the flexible material and smooth surface can be created, thereby holding the suction cup to the smooth surface. An object or objects attached to the suction cup can thus be attached or coupled to the smooth surface in this manner. One example of such an object is a portable shade or sign that is attached to one or more suction cups for placement on a window of an automobile or other vehicle.

In many instances, such suction cups require relatively smooth surfaces in order for a suitable seal to be made between the flexible suction cup material and the surface to which it is to be attached or coupled. Glass and some plastics are examples of materials that typically have smooth enough surfaces to which many suction cups can form a suitable seal. Other more relatively rough surfaces, however, are typically not suitable for use in conjunction with suction cups. Seemingly smooth surfaces, such as leather, vinyl, and many metals and woods, tend to have enough variances or roughness at a microscopic level so as to frustrate the ability of a suction cup to make a seal with such a surface. Accordingly, many suction cups are simply not designed for or intended for use with such surfaces that are relatively rough with respect to glass or smooth plastic surfaces.

While various suction cups and techniques of using same to couple objects to glass and other smooth surfaces have generally worked well in the past, there is always a desire to provide improved devices or techniques that can achieve the same objectives in a reliable fashion with respect to relatively rougher surfaces.

Tripods are another type of device that can be used to mount or support various objects. Typical tripod assemblies consist of three rigid legs, which are splayed out to form a support structure for devices such as cameras. The legs are usually rigid and adapted to provide support off of the ground or other flat surface. Some tripods have some adjustment to leg length which may allow for some deviation from flatness in the surface upon which they are mounted. Such tripods can be relatively limited in the manner in which they support devices.

For example, where a surface is not flat or close to flat, many such tripods simply do not work well. In addition, traditional tripod legs tend to stand or rest atop a surface, with little to no fastening or “cling” from leg to surface. Still further, many tripods employ a standardized screw or post that is adapted to couple to many different brands and makes of cameras. While sometimes useful, such screws and posts are often limited in application with respect to attaching or coupling a camera or other object to the subject tripod.

While various tripods and techniques of using same to support cameras and other objects have generally worked well in the past, there is always a desire to provide improved devices or techniques that can achieve the same objectives with respect to non-flat surfaces and coupling mechanisms other than posts or screws.

### SUMMARY

It is an advantage of the present invention to provide suction cups that are adapted to couple and uncouple objects to relatively rough surfaces in a quick and easy manner. This can be accomplished at least in part through the use of a suction cup having a flexible sealing member made of a low durometer material coupled to a sturdy backing member adapted to pull a central portion of the sealing member away from the rough surface. The use of such a low durometer flexible sealing member results in a greater ability to effect a seal against a rough surface, while the use of the sturdy backing member helps to pull the low durometer material away from the rough surface within the sealed off region so as to create a zero or low pressure region that facilitates the overall coupling of the suction cup to the rough surface.

In various embodiments, a suction cup is adapted for attaching or coupling a camera, personal device, tripod leg or other object to a rough surface. The suction cup can include a flexible sealing member, a sturdy backing member and a release mechanism. The flexible sealing member can have a continuous first surface adapted to be placed flush against an external rough surface such that a zero or low pressure region can be formed between the first surface and the external rough surface. The backing member can be coupled to a second surface of said flexible sealing member opposite the first surface, and can be adapted to pull a central portion of the sealing member away from the external rough surface so as to create the zero or low pressure region, thereby creating a suction hold against the external rough surface. The release mechanism can be adapted to diminish the suction hold against the external rough surface when the release mechanism is activated by a user. The external rough surface can have a surface roughness Ra of about 2 microns or more, although a surface roughness Ra of about 5 microns or even 10 micron or more is also possible. In some embodiments, the first surface of the flexible sealing member can be formed from a material having a durometer rating of less than about 50, shore A. Materials having a durometer rating of less than about 30, or even less than about 10, shore A may also be used. As one example, said first surface can be formed from a low durometer rubber or plastic.

In various embodiments, the inventive suction cup can further comprise a rigid outer shell disposed above the flexible sealing member and the backing member, wherein an outer circumference or rim of this outer shell can be used to facilitate a seal between the flexible sealing member and the external rough surface. This outer shell can also house at least a portion of the release mechanism. In various embodiments, the release mechanism can include a button or lever adapted to push the backing member toward the external rough surface when the button or lever is activated by a user, which also thereby pushes the central portion of the flexible sealing member toward the external rough surface. This button or lever can also adapted to pull the backing member away from the external rough surface when the button or lever is activated by a user, thereby also pulling the central portion of the flexible sealing member away from the external rough surface so as to create a zero or low pressure region therebetween.

In some embodiments, the rigid outer shell can have a clip mating portion integrated therein, with such a clip mating portion being adapted to be inserted into a receiving portion of an associated clip. In such embodiments, the release mechanism can be adapted to remain inaccessible to a user while the clip mating portion is inserted into the receiving portion of the associated clip.

In various embodiments, the backing member can include one or more openings situated therein, whereby portions of the flexible sealing member are sucked into such one or more openings when a zero or low pressure region is created between the flexible sealing member and the external rough surface. Such openings can comprise holes through the backing member. Alternatively, the backing member can comprise a plurality of strands or fingers connected at a central hub region and having openings therebetween.

In still further embodiments of the present invention, various applications of suction cups can include use in conjunction with a tripod or other similar mounting device. A tripod adapted to support an object thereon can include a body portion, a plurality of flexible legs, an interconnect portion coupled to the body portion, a clip receiver coupled to the interconnect portion, and a mounting clip removably inserted into the clip receiver, with said clip comprising a main body and a suction cup coupled to the main body, wherein the suction cup is adapted to support a rough surface of an object thereon. Each of the flexible legs can include a first end and a second end, with the first end coupled to the body portion. The second end of one or more legs may be coupled to a respective suction cup. One or more of the subject suction cups can be one of the suction cups provided above, and may have one or more of the various suction cup features provided above.

The various suction cups and/or other mounting clips may be used with a tripod or a monopod, and in some embodiments a tripod with flexible legs utilizing ball and socket joint connectors which, when interconnected, form a flexible assembly. Each connector includes a body with a first and second end portion. An external socket engaging surface is provided at one end of the body. The other end of the body has an internal cavity. The socket engaging surface of one connector is snapped into the internal cavity of another to interconnect the connectors. In some embodiments, the ball and socket joint connectors utilize an over-molded strip around the outside of the connector to facilitate in their use for gripping.

As will be readily appreciated, various features from one or more of these embodiments may be incorporated into one or more of the other embodiments. Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the inventive suction cups for rough surfaces and methods of using same disclosed herein. These drawings in no way limit any changes in form and detail that may be made to the invention by one skilled in the art without departing from the spirit and scope of the invention.

FIG. 1 illustrates in side perspective view an exemplary suction cup adapted to couple an object to a surface.

FIG. 2 illustrates in top perspective view the exemplary suction cup of FIG. 1 coupling an object to a pane of glass.

FIG. 3 illustrates in top perspective view an exemplary suction cup adapted to couple objects to rough surfaces according to some embodiments of the present invention.

FIG. 4 illustrates in top perspective partially exploded view the exemplary suction cup of FIG. 3 according to some embodiments of the present invention.

FIG. 5 illustrates in side cross-sectional view the exemplary suction cup of FIG. 3 placed against a rough surface in a non-activated position according to some embodiments of the present invention.

FIG. 6 illustrates in side cross-sectional view the exemplary suction cup of FIG. 5 placed against the same rough surface in an activated position according to some embodiments of the present invention.

FIG. 7 illustrates in top plan view an exemplary backing member for use with a suction cup adapted to couple objects to rough surfaces according to some embodiments of the present invention.

FIG. 8 illustrates in top plan view an alternative exemplary backing member for use with a suction cup adapted to couple objects to rough surfaces according to some embodiments of the present invention.

FIG. 9 illustrates in side cross-sectional view an alternative exemplary suction cup placed against a rough surface in a non-activated position according to some embodiments of the present invention.

FIG. 10 is a perspective view of a suction clip according to some embodiments of the present invention.

FIG. 11 is a perspective view of a suction clip according to some embodiments of the present invention.

FIG. 12 is a side view of a suction clip according to some embodiments of the present invention.

FIG. 13 is a rear view of a suction clip according to some embodiments of the present invention.

FIG. 14 is a side view of a suction clip according to some embodiments of the present invention.

FIG. 15 is a bottom view of a suction clip according to some embodiments of the present invention.

FIG. 16 is a top view of a suction clip according to some embodiments of the present invention.

FIG. 17 is a perspective view of a suction clip in the open position according to some embodiments of the present invention.

FIG. 18 is a side view of a suction clip in the open position according to some embodiments of the present invention.

FIG. 19 is a rear view of a suction clip in the open position according to some embodiments of the present invention.

FIG. 20 is a bottom view of a suction clip in the open position according to some embodiments of the present invention.

FIG. 21 is a cross-sectional view of a suction clip according to some embodiments of the present invention.

FIG. 22 is a perspective of a suction cup according to some embodiments of the present invention.

FIG. 23 is a perspective view of a tripod and a suction clip according to some embodiments of the present invention.

FIG. 24 is a top perspective view of a flash clip according to some embodiments of the present invention.

FIG. 25 is a bottom perspective view of a flash clip according to some embodiments of the present invention.

FIG. 26 is a top view of a flash clip according to some embodiments of the present invention.

FIG. 27 is a side view of a flash clip according to some embodiments of the present invention.

FIG. 28 is a rear view of a flash clip according to some embodiments of the present invention.

FIG. 29 is a sketch of a unipod with a suction clip according to some embodiments of the present invention.

FIG. 30 is a sketch of a unipod with an electronic device mounted on it according to some embodiments of the present invention.

FIG. 31 illustrates a side view of a plurality of connected connectors according to some embodiments of the present invention.

FIG. 32 illustrates an end view of a plurality of connected connectors according to some embodiments of the present invention.

FIG. 33 is a cross-sectional view of a plurality of connected connectors according to some embodiments of the present invention.

FIG. 34 is a side view of a connector according to some embodiments of the present invention.

FIG. 35 is a cross-sectional view of a connector according to some embodiments of the present invention.

FIG. 36 is illustrates a connector with a gripping portion according to some embodiments of the present invention.

FIGS. 37 and 37A are a side and cross-sectional view of a connector with a gripping portion according to some embodiments of the present invention.

FIG. 38 is an illustration of a tripod apparatus according to some embodiments of the present invention.

FIG. 39 is an illustration of a body and interconnect portion of a tripod apparatus according to some embodiments of the present invention.

FIG. 40 is a cross-sectional view of a body and interconnect portion of a tripod apparatus according to some embodiments of the present invention.

FIG. 41 is an illustration of a tripod apparatus according to some embodiments of the present invention.

FIG. 42 is a side and cross-sectional view of a body and interconnect portion of a tripod apparatus according to some embodiments of the present invention.

FIG. 43 is a side and cross-sectional view of a body and interconnect portion of a tripod apparatus according to some embodiments of the present invention.

FIG. 44 is a side and cross-sectional view of a body and interconnect portion of a tripod apparatus according to some embodiments of the present invention.

FIG. 45 is a top perspective view of a clip according to some embodiments of the present invention.

FIG. 46 is a side view of a clip according to some embodiments of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The invention relates suction cups adapted to couple objects to objects or other external surfaces that are significantly rougher than many glasses or smooth plastics, and various applications of such suction cups. Rough surface suction cups can have a flexible sealing member made of a low durometer material coupled to a sturdy backing member adapted to pull a central portion of the sealing member away from the rough surface so as to create a low pressure region therebetween. A rigid outer shell disposed above the flexible sealing member and the backing member includes an outer circumference or rim that is used to facilitate the creation of a seal between the flexible sealing member and the external rough surface.

### Suction Cups for Rough Surfaces

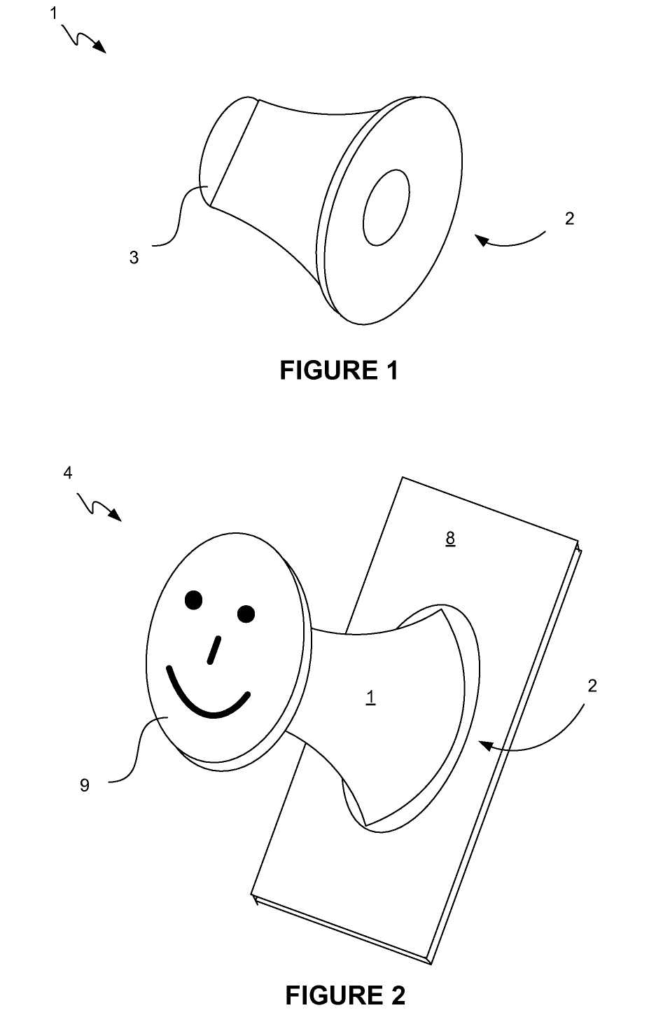

Referring first to FIG. 1, an exemplary suction cup adapted to couple an object to a surface is shown in side perspective view. Suction cup 1 can include a curved and flexible sealing surface 2 adapted to form a suction seal against a smooth surface and an opposing end or connector region 3 adapted to connect the suction cup to an object, such as a sign, window shade or various other objects. FIG. 2 illustrates in top perspective view the exemplary suction cup of FIG. 1 coupling an object to a pane of glass. Suction cup arrangement 4, includes suction cup 1, which couples smiley face button 9 to pane of glass 8. Although not visible from this perspective, the sealing surface 2 has been pressed flat or substantially flat against glass pane 8, which deforms much of suction cup 1 to some degree. As the suction cup tries to revert back to its original shape, sealing surface 2 is raised a bit off glass pane 8, thereby creating a low pressure region or volume, or even a vacuum (zero pressure region or volume). This resulting low pressure region then serves to hold the suction cup 1 and coupled button 9 in place against the glass pane 8.

One drawback to this typical suction cup arrangement 1 is that the subject surface 8 usually must be a pane of glass, smooth plastic, or other similarly smooth surface. In the event that such a surface is wood, an unfinished metal, wallboard or any other similar rough surface, it can be difficult or impossible to form a suitable seal between sealing surface 2 and the subject rough surface. This is largely due to the inherent microscopic cavities and deformations in such rough surfaces, which prevent the formation of an adequate seal. For example, many firm rubber suction cups cannot create a suitable seal against a surface having a roughness Ra of about 2 microns or more, and some are unable to create a suitable seal even when the surface roughness Ra is on the order of about 1 micron or more.

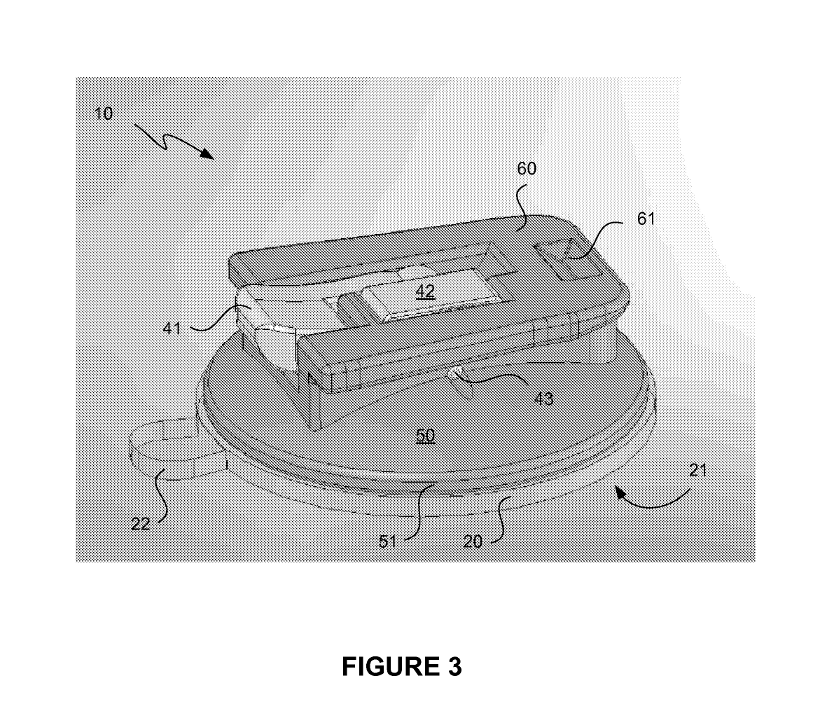

Moving next to FIG. 3, an exemplary suction cup adapted to couple objects to rough surfaces according to one embodiment of the present invention is shown in top perspective view. Although suction cup 10 as illustrated can include various features suitable for use as a clip and an associated clip receiver, as set forth in greater detail below, it will be readily appreciated that such clip features are not necessary for the suction cup to operate as a fastener or coupler to a relatively rough surface. Suction cup 10 is preferably adapted such that it can form a suitable seal when a sealing member is placed flush against a surface having a roughness Ra of about 2 microns or more. In various embodiments, a suitable seal may even be formed against a surface having a roughness Ra of about 5 microns or more, or even 10 microns or more. In the event that a seal is desired against an increasingly rough surface, then the material chosen for the flexible sealing member of the suction cup can be even more pliable (i.e., have a lower durometer rating).

Suction cup 10 can include a flexible sealing member 20, a backing member (not shown), various parts of a release mechanism 41, 42, 43 a rigid outer bowl or shell 50 and a clip portion 60 having one or more clip related features 61 integrated with the outer bowl or shell. The flexible sealing member 20 is the portion of suction cup 10 that is adapted for sealing against an external rough surface, and particularly surface 21 of sealing member 20 is used to effect a seal and suction against the rough surface. Sealing member 20 can be made from a variety of pliable materials, such as, for example, various rubbers or plastics.

Because sealing member 20 is to form a seal against a rough surface, it is preferable that the material from which it is made is relatively soft, so as to at least partially fill the various nooks and crannies on the rough surface to enable a seal. For example, surface 21 can be formed from a rubber or other suitable material having a durometer rating of less than about 50, shore A, which is thought to work well for the purposes disclosed herein. In the event that a seal is desired against even rougher surfaces, then surface 21 can be formed from a material having a durometer rating of less than about 30, or even less than about 10, shore A. For the various uses described herein, a low durometer rubber works well. Alternatively, sealing member 20 can be formed from a putty or any other ductile or malleable material suitable for forming a seal against a rough surface at one location while also being pulled away from the rough surface at another location.

Because the rubber or other suitable material used to form first or mating surface 21 of flexible sealing member 20 is so soft and as such cannot be relied upon to provide its own rigidity or spring action, additional devices and features are preferably used with suction cup 10. Rigid outer shell 50 can include a rim or outer circumference 51 adapted to transfer force or pressure to an outer region of flexible sealing member 20 so as to help effect a seal against the external rough surface. In addition, an internal backing member (not shown) situated between the flexible sealing member 20 and outer shell 50 can be embedded within or coupled to a central portion of the sealing member to aid in pulling a portion of the sealing member away from the rough surface. When a seal is formed along the outer portion of the sealing member and the central portion of the sealing member is pulled away from the rough surface, then a volume or region of zero or low pressure is created between the sealing member of the suction cup and the rough surface. A suction hold is thereby created against the external rough surface, as will be readily appreciated.

Although rim or outer circumference 51 of outer shell 50 may be stiff in some embodiments, other alternative embodiments may provide for some flexibility or bending in the outer shell at this rim region. Such flexing or movement in the outer rim 51 where the seal against the rough surface is to be formed can allow for seals to be formed against curved or somewhat irregular rough surfaces as well. For example, where rim 51 is somewhat flexible yet still firm enough to exert force to create a seal between the sealing member 20 and external surface, then seals might still be possible against rough surfaces having a spherical shape within certain ranges, depending upon the dimensions of each item and the level of flexibility in the outer rim.

A release mechanism can include release lever 41, a cam or other connecting component 42 and a hinge pin 43, among other possible parts. In some embodiments, connecting component 42 may be eschewed in lieu of a direct link with the backing member itself. As shown in FIG. 3, suction cup 10 is shown in a closed or “activated” position. As such, the release lever 41 is in a down position, which results in the backing member being pulled away from the rough surface and suction being applied thereby. In the event that a user wishes to release the suction cup from its suction hold against the rough surface, then release lever can be moved to an open position, which then results in the backing member being pushed back toward the rough surface. This can then result in the pressure within the low pressure area increasing, such that the suction cup is more readily removed from the rough surface. In the event that further assistance is needed for such removal, a release tab 22 formed with flexible sealing member 20 can be lifted by the user to help reduce or eliminate any remaining suction hold.

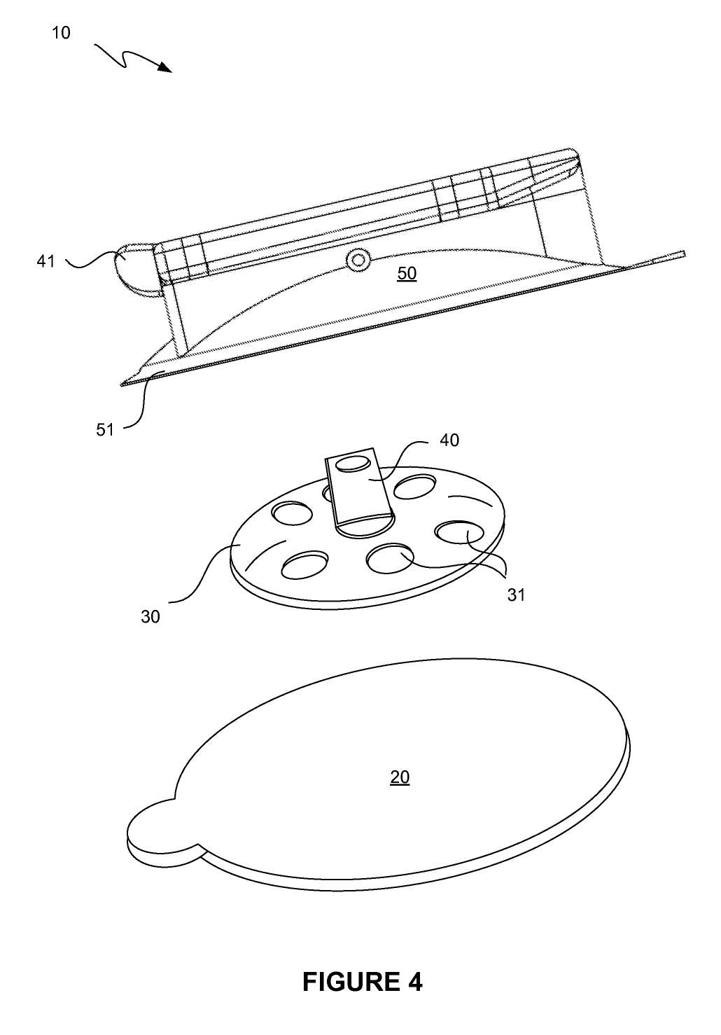

Continuing now to FIG. 4, the exemplary suction cup of FIG. 3 is shown in top perspective partially exploded view. As shown, flexible sealing member 20 can generally comprise a continuous shape, such as a circle or oval. The bottom or first surface of the flexible sealing member is adapted for sealing to an external rough surface, while the upper or second surface can be adapted for coupling to a backing member 30. Such a fastening or coupling of sealing member to backing member can be made by way of gluing, welding, stapling, riveting, molding, overmolding, double injection molding or any other suitable fastening or coupling technique. Backing member 30 can have a plurality of openings 31 situated thereabout, such that corresponding portions of sealing member 20 can actually be sucked into these openings when there is a suction hold in place. Such openings can thus facilitate more displacement of the sealing member, and thus create a greater volume of space between the sealing member and rough surface, which in turn lowers the pressure of the low pressure region.

In addition, because the flexible sealing member 20 is comprised of a material that is so soft and generally lacking in any resiliency or spring action, backing member 30 preferably contacts or otherwise covers a significant amount of area on the sealing member. That is, when the backing member 30 is actuated or activated to pull away from the general direction of the rough surface, the central portion of the sealing member is thereby pulled away as well, so as to create a vacuum or low pressure region between the sealing member and the rough surface. Such a pulling of the pliable sealing member by the more rigid backing member can be due to direct contact between the two components. In some embodiments, the area of the sealing member central portion pulled by the backing member can comprise at least 30 percent of the overall area of the flexible sealing member, with much or all of this area being contacted directly by the backing member. In some embodiments, the area of the sealing member pulled by the backing member can comprise at 50 percent or more of the overall area of the flexible sealing member. Furthermore, although these areas are expressed with respect to a central portion of the flexible sealing member, it will be readily appreciated that other off-center portions of area may also be suitably pulled away from the rough surface so as to create a low pressure region.

A suitable tab or other release component 40 can be formed as an upper portion of backing member 30. This release component is adapted to operate in conjunction with other release parts, such as release lever 41 and/or cam 42 that effect the relative up or down movement of backing member 30, and thereby sealing member 20. Release component 40 may be affixed or otherwise coupled to backing member 30, or may be integrally formed with the backing member. As noted above, outer shell 50 can include an outer circumference or rim that can be used to exert force on an outer portion of the flexible sealing member, so as to readily effect a seal against the external rough surface.

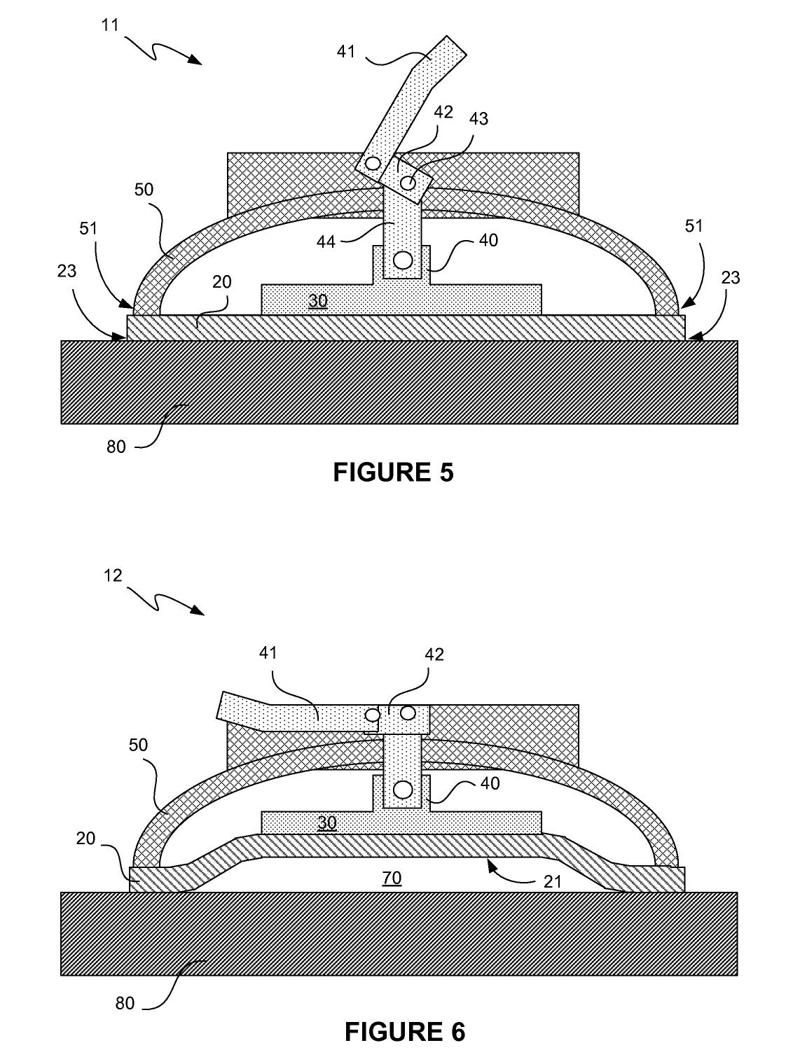

FIG. 5 illustrates in side cross-sectional view the exemplary suction cup of FIG. 3 placed against a rough surface in a non-activated position according to some embodiments of the present invention. Suction cup 11 is shown in an open or “non-activated” position, meaning that there is no effective zero or low pressure region between the suction cup and rough surface 80, and as such no suction hold. This open position is preferably the position used when suction cup 11 is applied to or removed from rough surface 80. When the suction cup is applied, the user can direct force downward onto outer shell 50 such that its outer rim 51 presses downward against an outer portion of sealing member 20. A seal 23 is then formed between the sealing member 20 and rough surface 80 at the region generally around this rim 51. Once the seal is formed, lever 41 can be activated, which can result in the activation of various parts or components 42, 43, 44 that then ultimately act to pull upward on release component 40 of backing member 30. As noted above, such parts or items 42, 43, 44 simply reflect that a variety of mechanical mechanisms can be used to activate and release the suction cup. In fact, some embodiments may even have release component 40 connected directly to release lever 41.

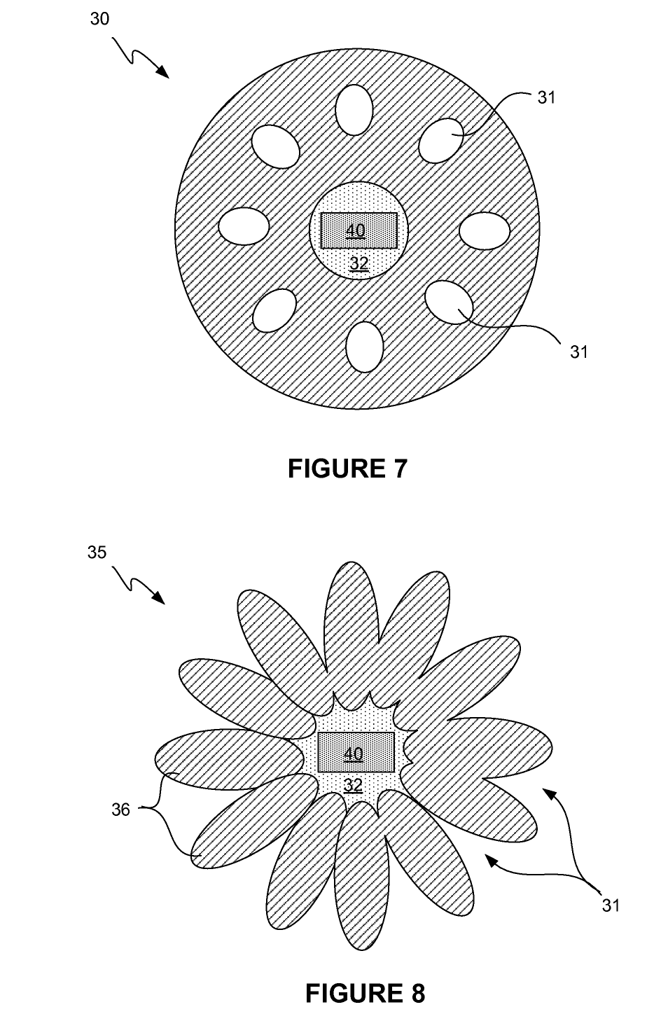

Continuing next to FIG. 6, the exemplary suction cup of FIG. 5 placed against the same rough surface, but only in an activated position, is also shown in side cross-sectional view. As shown, the release lever 41, which is also an actuating lever in this instance, has been pushed downward to activate the suction cup. This results in release component 40 and backing member 30 being pulled away from rough surface 80, which in turn pulls a central portion of sealing member 20 away from the rough surface as well, exposing first or sealing surface 21. The resulting volume or region 70 is then a zero or low pressure region, and a suction hold between the suction cup and rough surface is thereby created.

Referring now to FIGS. 7 and 8, various exemplary backing members for use with the foregoing suction cups are shown in top plan view. Backing member 30 is adapted to couple to a sealing member, and is identical or substantially similar to the backing member illustrated previously. A plurality of openings or holes 31 are formed therethrough, such that added gripping or sucking action on the sealing member can be had when a suction hold against the rough surface is applied. As noted above, a central hub or portion 32 can include a release component 40 that extends upward to interact with a release lever and/or other release components.

With respect to FIG. 8, an alternative backing member 35 includes a plurality of strands or fingers 36 distributed about a central hub region 32. Under this alternative arrangement, a plurality of openings 31 or gaps still exist within or about the alternative backing member 35, such that the sealing member is similarly partially pulled therethrough when a suction hold is applied. As in the above embodiments, a release component 40 can be attached to or integrally formed with backing member 35 so as to facilitate the ready creation of a suction hold and release thereof.

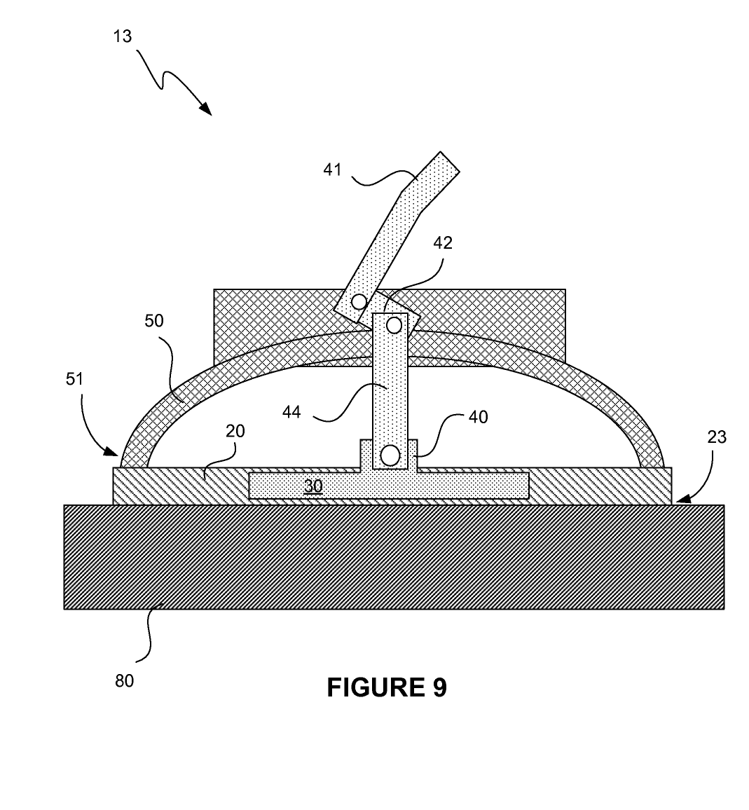

Continuing next to FIG. 9, an alternative exemplary suction cup placed against a rough surface in a non-activated position is illustrated in side cross-sectional view according to some embodiments of the present invention. Suction cup 13 is significantly similar in many regards to the various suction cups shown and described previously. Unlike the various embodiments illustrated above, however, suction cup 13 includes a backing member 30 that is embedded within flexible sealing member 20. Whether attached to a back surface or embedded within the relatively soft sealing member 20, backing member 30 provides a level of rigidity and force that is typically not available for such a soft material sealing member standing alone.

### Exemplary Clip and Tripod Applications

Various embodiments of the foregoing suction cups designed for coupling to rough surfaces can be used in a variety of applications. Such applications can include, for example, use in conjunction with a clip and/or tripod or monopod. As one example, one or more of the foregoing suction cups may be coupled to the end of a tripod or monopod leg, such as the various tripods and monopods set forth in greater detail below. In this manner, one or more tripod or monopod legs can end in a suction cup that is adapted to be coupled to a rough surface, thus adding even more flexibility and variety in the use of such tripods and monopods. Other exemplary uses include utilizing one of the foregoing suction cups as a fastener or coupling device at the head or top of the tripod. Such uses may involve the suction cup being a part of a clip that can snap in and out of a clip receiver atop the monopod or tripod. Such a suction cup and clip arrangement may be termed a “suction clip.”

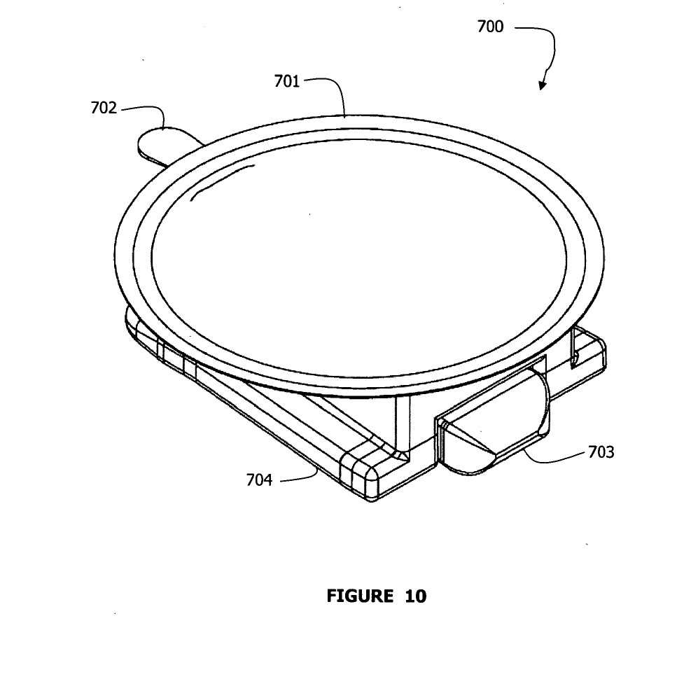

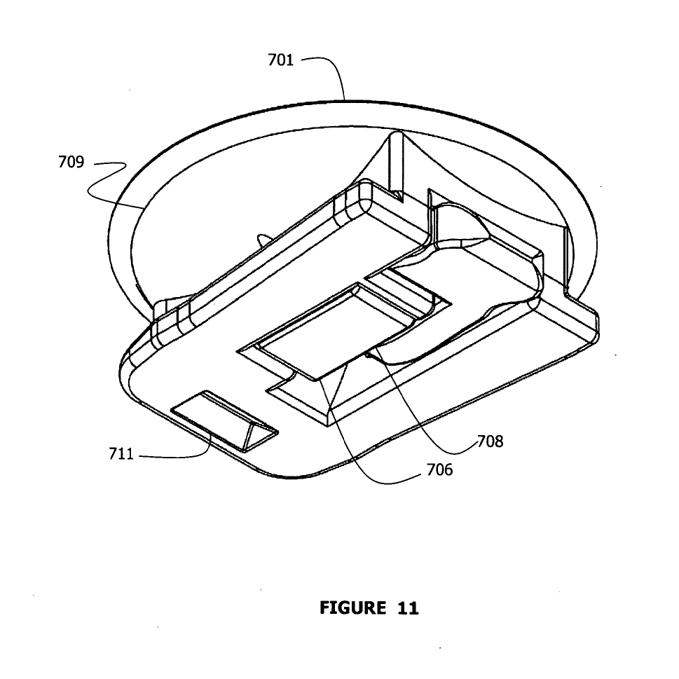

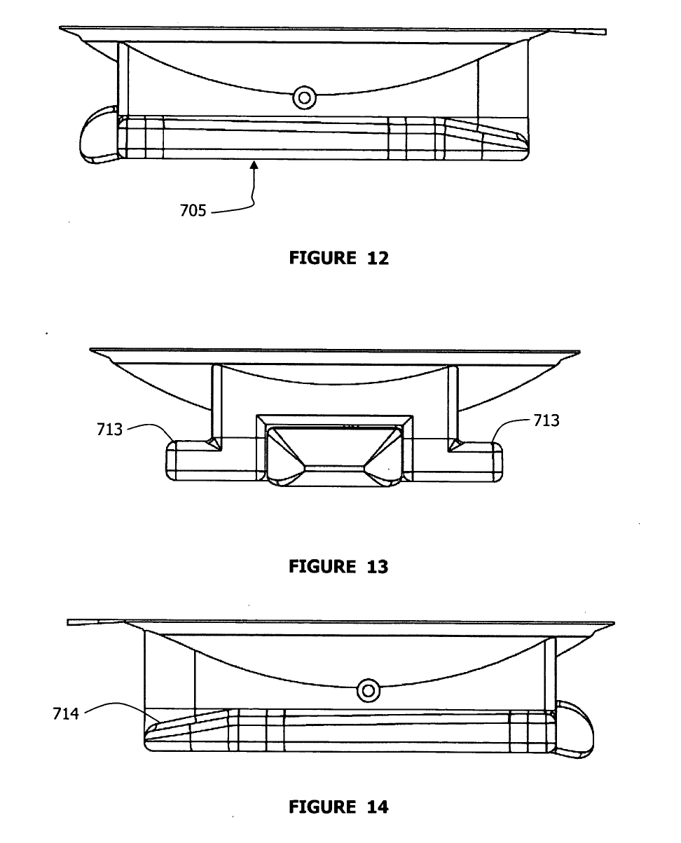

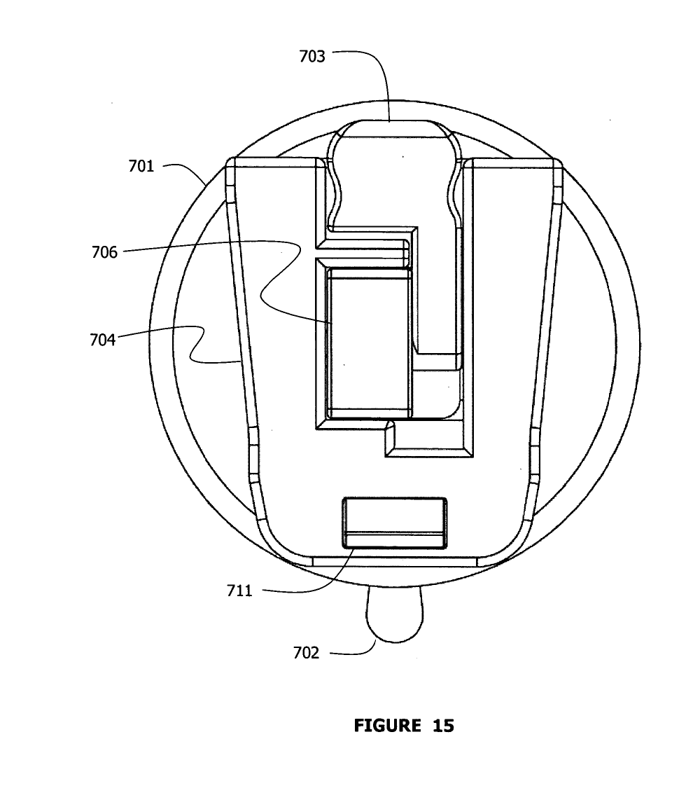

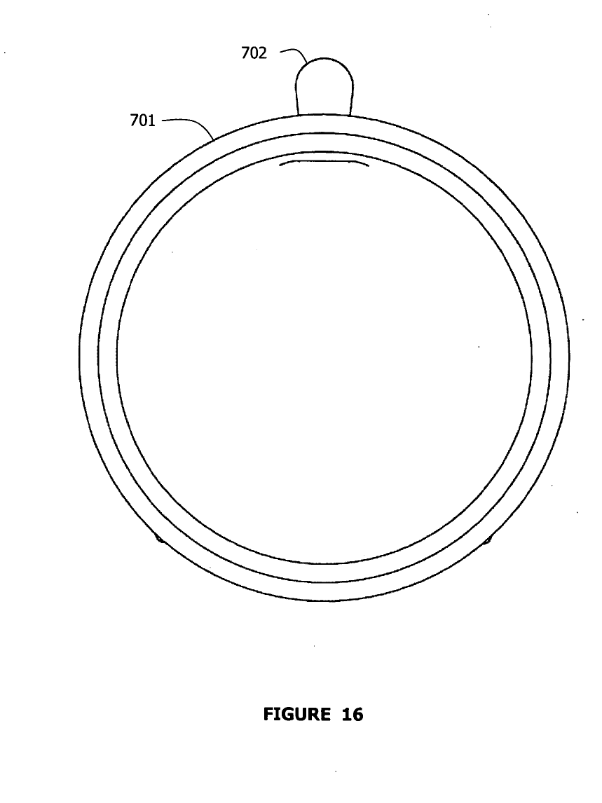

FIGS. 10-16 illustrate a suction clip 700 in a closed position according to some embodiments of the present invention. The suction clip 700 is adapted to be removably attached to a support structure such as a tripod or a unipod. A suction cup 701 is attached to and overlays the clip base 704. A release lever 703 is seen embedded within the clip base 704. A release tab 702 is attached to the suction cup 701. The clip base 704 is of a relatively rigid material such as a plastic or acetyl. The suction cup is of a more compliant material such as rubber or rubberized compound.

The suction clip 700 has a clip base 704 adapted to be clipped into a mating support structure. The clip base may have a flat bottom surface 705 and rails 713 along its sides, or along three sides. The rails 713 allow for the clip to be inserted into a mating interface which is adapted to receive a flat bottomed clip and which has grooves along its sides to receive the rails of the clip. A slot 711 is seen in the bottom surface 705 of the planar bottom of the clip base 704. The slot 711 is adapted to allow for the capture of the clip by a tab when slid into an interfacing portion of a support structure, such as a tripod. A neckdown 714 on the rail allows for easier insertion of the clip into its interfacing connector.

The suction clip may be used with a support structure as a removably attached clip. The removable aspect of the clip allows the support structure to be used with different types of clips when desired by the user. In addition, the user may want to attach the clip to the device and remove the device with the clip attached from the support structure.

A cup bowl 709 forms the upper part of clip base 704. The cup bowl 709 provides a bowl shaped support for the suction cup 701. Along the underside of the clip base 704 is a mechanism for providing suction, via the suction cup 701, to a surface of an item to be adhered to the suction clip 700. The release lever 703 is hinged to the suction cup base 706 around a hinge line 708. The release lever 703 is hinged to the clip base 704 with a hinge pin 707. The suction cup base is attached to the suction cup 701. In some embodiments, the suction cup base 706 is co-molded to the suction cup 701. FIG. 22 illustrates a suction cup assembly with the suction cup 701 co-molded to the suction cup base 706. The suction cup base may be of a relatively rigid material such as an acetyl, and the suction cup may be of a more ductile, rubberized material. The suction cup may also be designed for use with a rough surface, and can be any of the rough surface type suction cups described above.

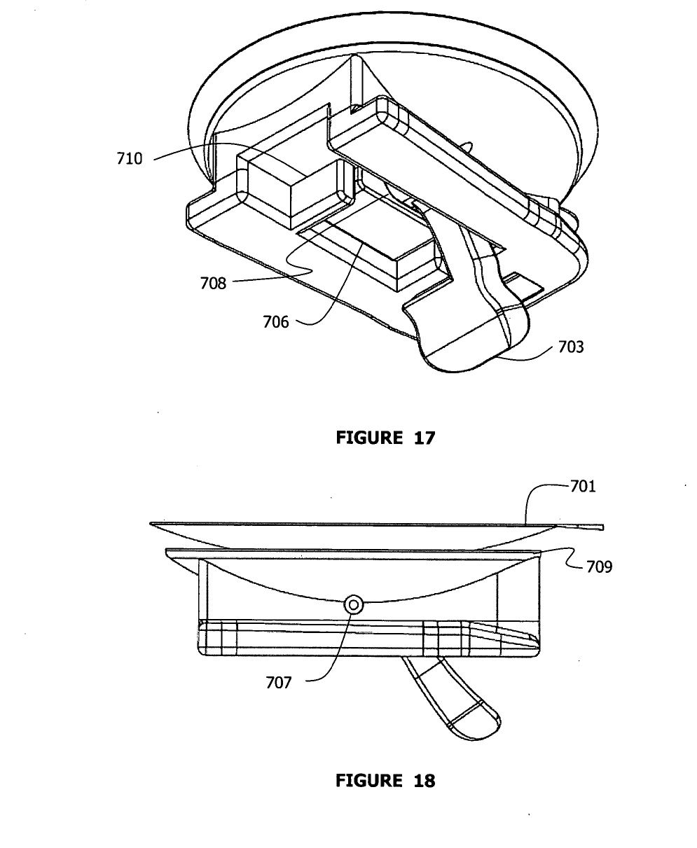

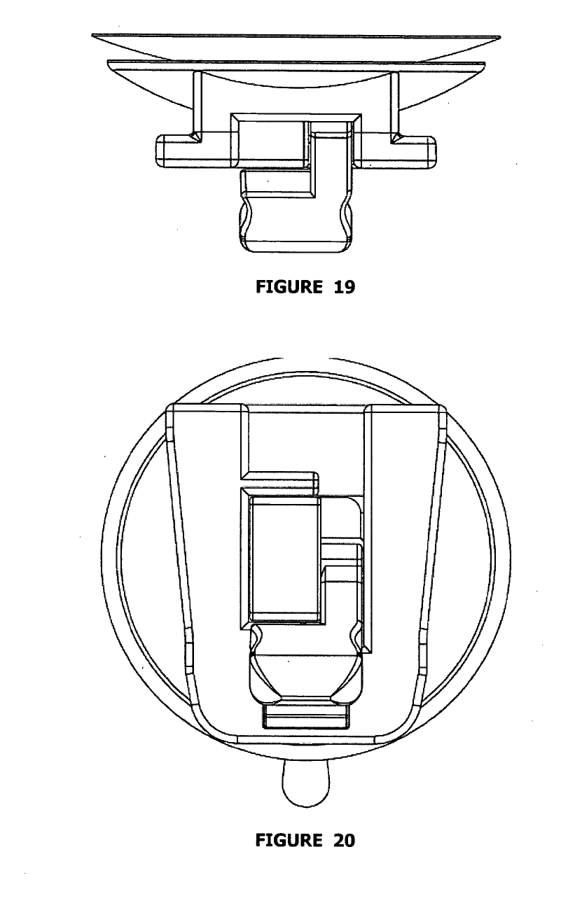

FIGS. 17-20 illustrate the suction clip 700 in an open position. A mechanism for applying suction via the suction cup to the item to be attached resides within the suction cup base 706. The release lever 703 has been rotated from a first closed position in plane with the bottom surface of the clip base to a second position. The rotation occurs around a hinge line 708. The rotation of the release lever 703 moves the suction cup base 706 upwards away from the bottom surface 705 of the clip base. As seen in FIG. 18, the suction cup 701 may also raise off of the suction cup bowl 709 with the raising of the suction cup base 706.

The release lever 703 has a cam 720 which fits within an opening 721 in the suction cup base 706. The movement of the release lever 703 raises or lowers the suction cup base 706 working with a cam motion. The cam 720 is rotationally fixed to the release lever 703. In some embodiments, the are a single piece. The pin is held in place in holes in the suction cup base 704.

The item to be adhered to the suction clip is placed on the suction cup while the release lever 703 is in the open position. Preferably a smooth planar portion of the item to be adhered is in contact with the suction cup. The outer periphery of the suction cup makes a seal on the item to be adhered to. The release lever is then moved from the second open position to the first, closed position. This motion of the release lever pulls the bottom of the suction cup down and away from the item to be adhered to. The bottom of the suction cup is pulled by the leveraged motion of the suction cup base, which is pivotally attached to the release lever. The pulling down of the suction cup base imparts lower or negative pressure to the area between the suction cup and the item, adhering the item to the suction clip. The suction cup base is pulled down through a guide hole through which the suction cup base may travel vertically. The suction cup bowl holds up the suction cup near its outer periphery but does not impede the pulling down of the central area of the suction cup. After release of the negative pressure, the item that had been adhered to by the suction cup can be helped to be released from the suction cup by the pulling of the pull tab 702. The use of such a clip that can be fastened to an item, such as a cell phone, flashlight, flash, camera, etc., separate from attachment to the support structure provides greater ease and more versatility for the user.

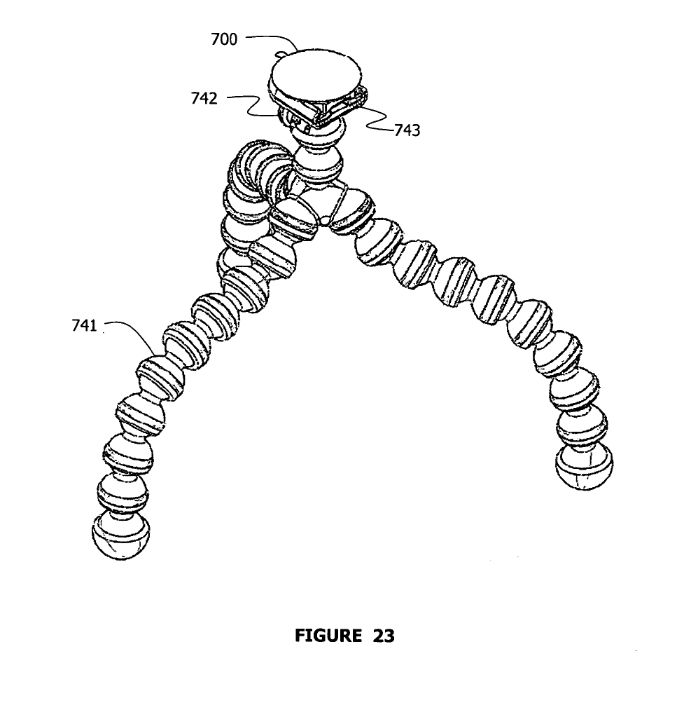

FIG. 23 is a sketch of a suction clip 700 attached to a tripod 741 according to some embodiments of the present invention. The clip base has been inserted into the interface portion 743 of the tripod. A release button 742 is adapted to allow for the easy removal of the suction clip 700. The release button 742 releases a tab that was in a slot on the bottom surface of the clip base.

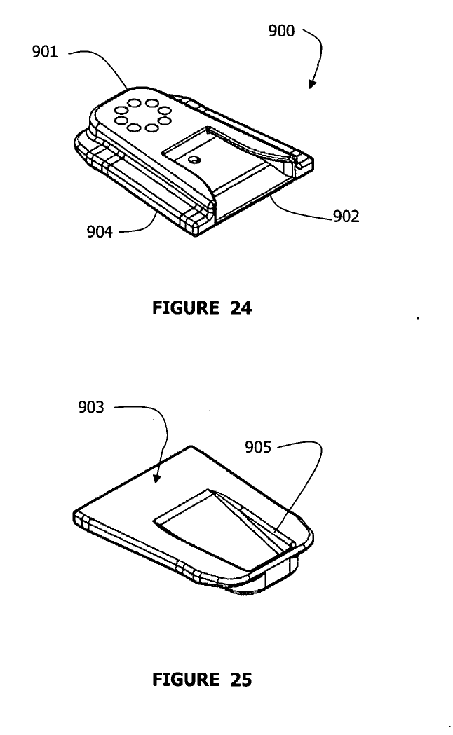

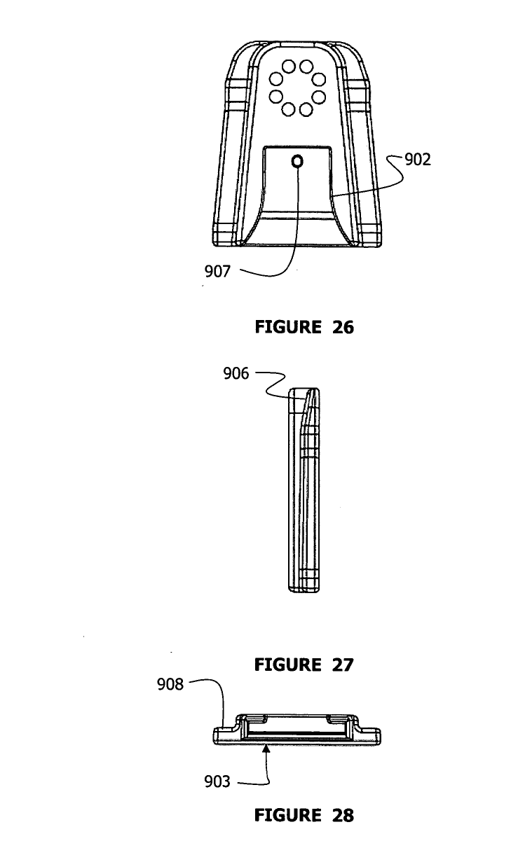

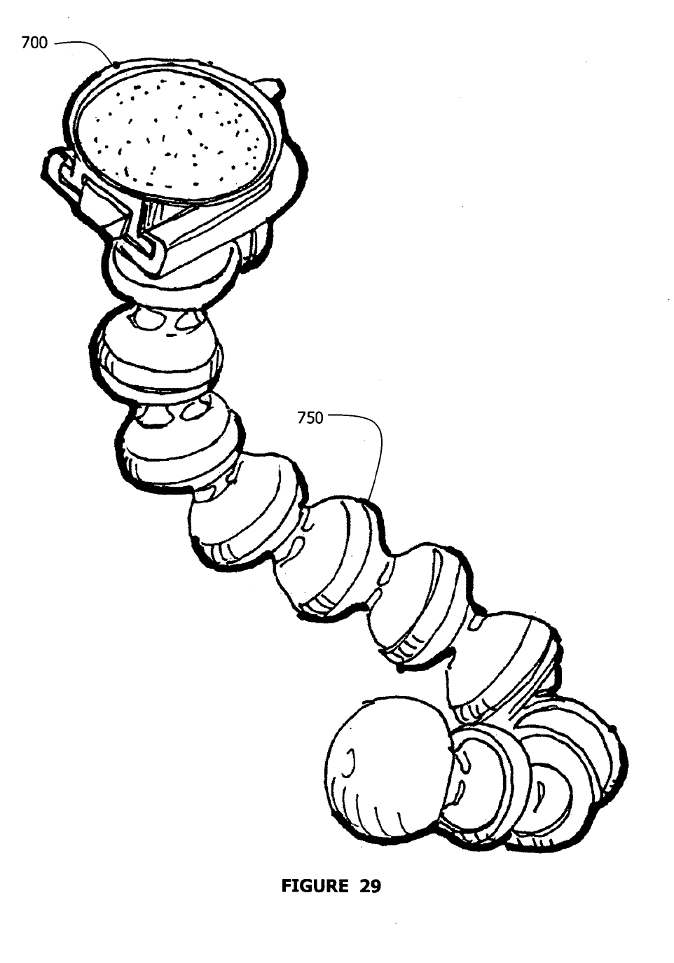

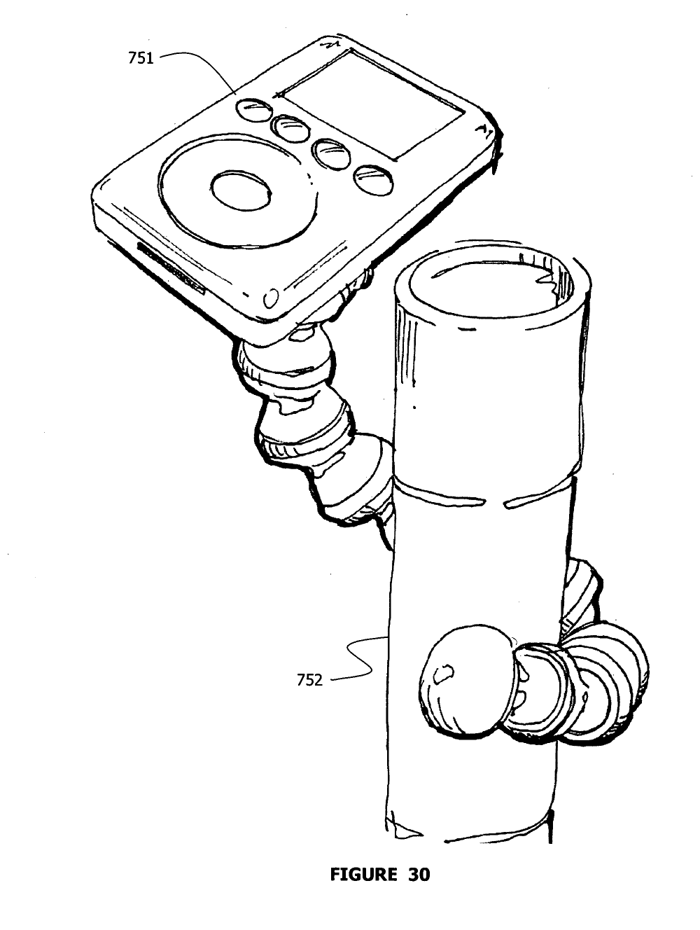

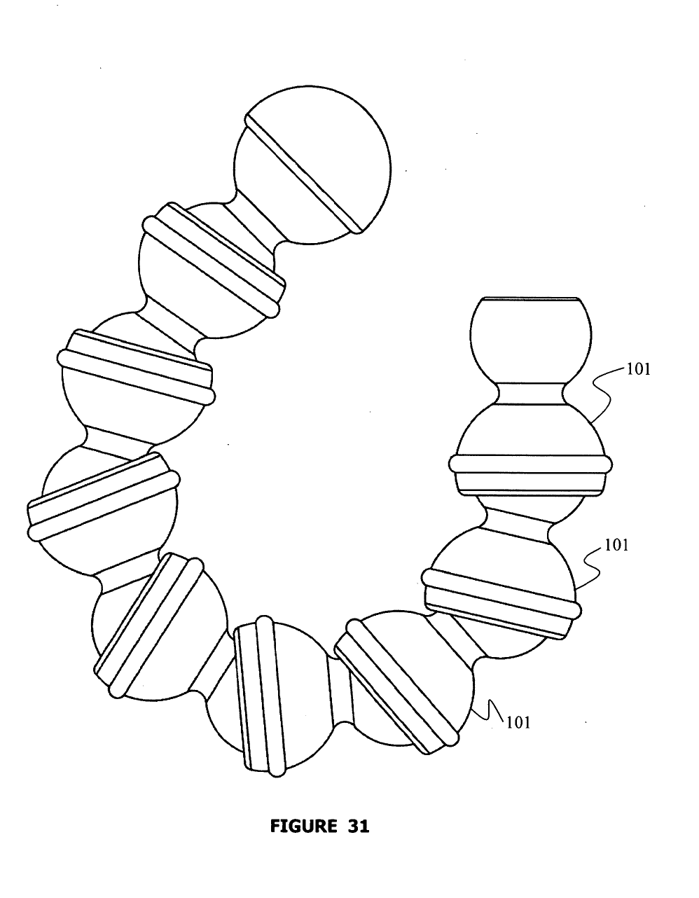

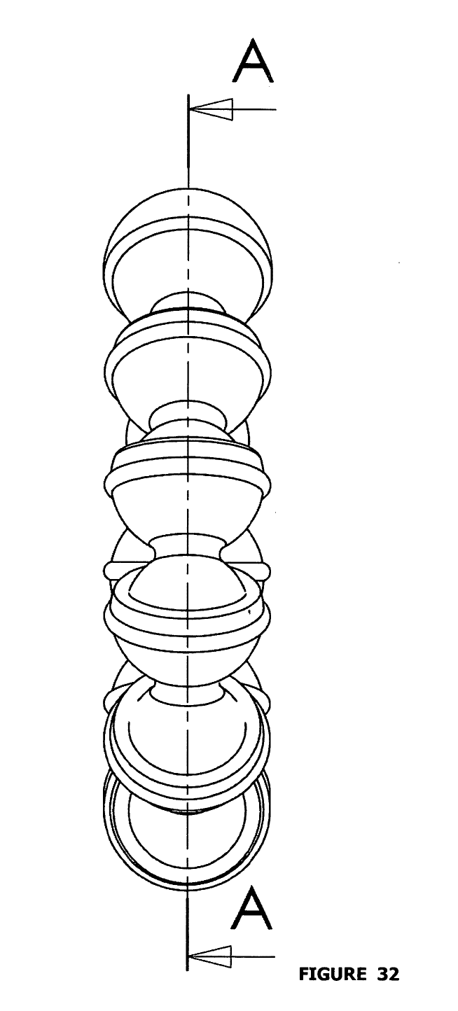

FIGS. 24-28 illustrate a flash clip 900 according to some embodiments of the present invention. The flash clip 900 is adapted to attach to a modern flash unit interface, and then be clipped into a support structure such as a tripod. The clip base may have a flat bottom surface 903 and rails 708 along its sides, or along three sides. The rails 708 allow for the clip to be inserted into a mating interface which is adapted to receive a flat bottomed clip and which has grooves along its sides to receive the rails of the clip. A slot 905 is seen in the bottom surface 903 of the planar bottom of the clip base 901. The slot 905 is adapted to allow for the capture of the clip by a tab when slid into an interfacing portion of a support structure, such as a tripod. A neckdown 906 on the rail allows for easier insertion of the clip into its interfacing connector.

An opening 902 is adapted to receive a modern flash unit. The mating structure of the flash unit slips into the opening 902 which has interior slots along its three sides. A hole 907 is adapted to receive a pin that extends from the flash unit. The flash unit may be a remotely fired unit such that the tripod, or other support unit, in which the flash and clip are mounted may be place in a position away from the camera. The clip allows mating of the flash to the clip in advance, and with ease, so that the clip/flash combo may be easily inserted into and removed from the support structure when desired.

FIGS. 29 and 30 illustrate a monopod, or unipod, with removably attached clips according to some embodiments of the present invention. A monopod 750 is seen with a series of ball and socket connectors with an overmolded grip strip as seen in other embodiments of the present invention. The monopod 750 may have an interface portion which is adapted to receive clips according to embodiments of the present invention. The monopod 750 allows for mounting to members, such as a vertical member 752. An electronic item 751, or other item, may be attached to a mounting clip and supported by the support structure.

FIGS. 31, 32, and 33 illustrate a plurality of ball and socket joint connectors 101 according to some embodiments of the present invention. A connector 101 has a first end portion 102 and a second end portion 103. A socket engaging end surface 104 is present at the first end 102. The first end portion 102 is substantially hollowed out.

The second end portion 103 has a body 106 with an internal socket receiving cavity 107. The inner surface 110 of the an internal socket receiving cavity 107 is adapted to fit over the socket engaging end surface 104 of another connector 101, or of another piece with a similar socket engaging end surface. A neckdown 105 separates the first end portion 102 from the second end portion 103. A stop nub 108 acts as a mechanical stop to prevent over angulation and possible unintentional separation of a ball and socket joint connector pair.

As seen in FIG. 34, the connector 101 has a primary axis 111 in some embodiments. The connector 101 may be symmetric around the primary axis 111 in some embodiments. The end surface planes of the first and second end portions of the connector may be perpendicular to the primary axis 111 in some embodiments.

In some embodiments of the present invention, the wall thicknesses of the internal socket receiving cavity or the socket engaging end surface, or both, are constructed so that an interference fit remains after the ball and socket joint connectors are connected. In some embodiments, the interference fit is designed such that the material is stressed to a stress level below that of the plastic limit but above the creep limit. The material may then creep until the interference is at or below the creep limit, typically down to the upper end of the elastic deformation stress range of the material. In such an embodiment using a plurality of connectors connected together to form a longer chain, the stresses will tend to equalize in the different connector pairs. This equalization of stresses will tend to equalize the frictions of the various connector pairs. An equalization of the frictions in the connector pairs in a long chain of connected connectors will tend to allow the chain of connectors to bend in a smooth fashion when the chain is subjected to bending forces. For example, in a 10 unit chain bent to a 45 degree angle, the bending may be well spread among the connector pairs.

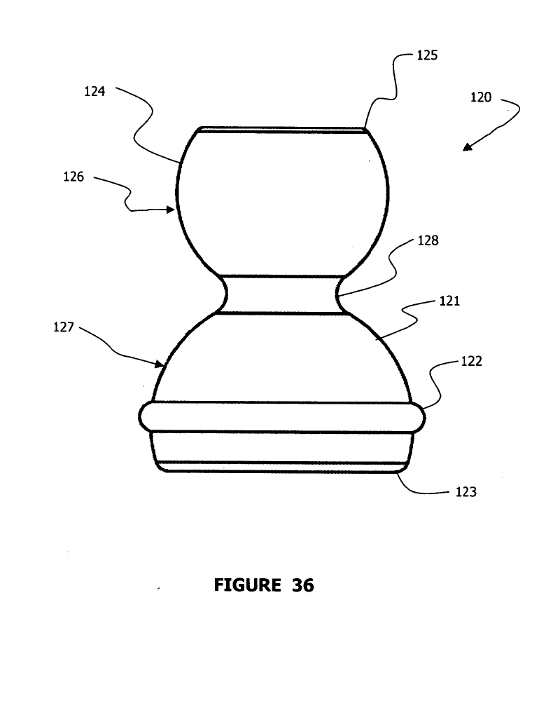

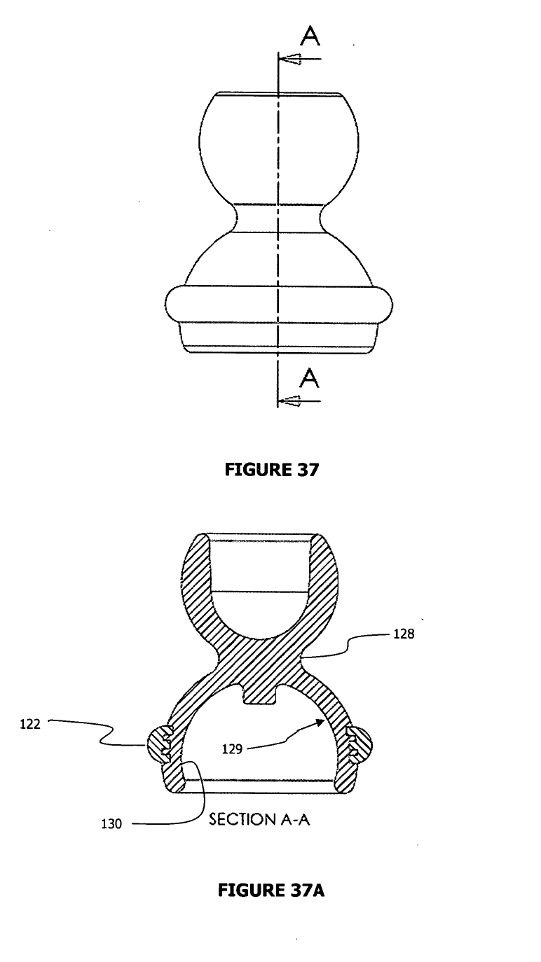

In some embodiments, as seen in FIGS. 36, 37 and 37A, a connector 120 includes a gripping portion 122. The connector 120 has a first end portion 125 and a second end portion 123. A socket engaging end surface 124 is present at the first end 125. The first end portion 125 is substantially hollowed out.

The second end 123 has a body 121 with an internal socket receiving cavity 130. The inner surface 129 of the an internal socket receiving cavity 130 is adapted to fit over the socket engaging end surface 124 of another connector, or of another piece with a similar socket engaging end surface. A neckdown 128 separates the first end portion 125 from the second end portion 123. A gripping portion 122 allows the connector to grip surfaces more readily. In some embodiments, the gripping portion is co-molded into the connector body. In some embodiments, the gripping portion is a rubberized compound. In some embodiments, the gripping portion is a circumferential ring molded into the outer surface of the connector. The gripping portion may provide a higher friction interface when the connector is set upon or wrapped around an object.

In some embodiments of the present invention, the outer surface 109 of the socket engaging end surface 104 may be lubricated. Lubrication of the outer surface 109 of the socket engaging end surface 104 may allow for more even frictions between various connections in a chain of connectors. In some embodiments, the inner surface 110 of the internal socket receiving cavity 107 may be lubricated. Lubrication of the inner surface 110 of the internal socket receiving cavity 107 may allow for more even frictions. In some embodiments, both the outer surface 109 of the socket engaging end surface 104 and the inner surface 110 of the an internal socket receiving cavity 107 may be lubricated. In some embodiments, the surfaces may be coated with an adhesive. With some connector materials, such as acetyl materials, Delrin, and Nylon, compounds normally used as adhesive may function as a lubricant when used in an interference fit ball and socket joint connector.

In some embodiments of the present invention, the outer surface 109 of the socket engaging end surface 104 may be textured. The texture may take the form of a surface roughness. Texturing of the outer surface 109 of the socket engaging end surface 104 may allow for more even frictions between various connections in a chain of connectors. In some embodiments, the inner surface 110 of the internal socket receiving cavity 107 may be textured. The texture may take the form of a surface roughness. Texturing of the inner surface 110 of the internal socket receiving cavity 107 may allow for more even frictions. In some embodiments, both the outer surface 109 of the socket engaging end surface 104 and the inner surface 110 of the an internal socket receiving cavity 107 may be lubricated.

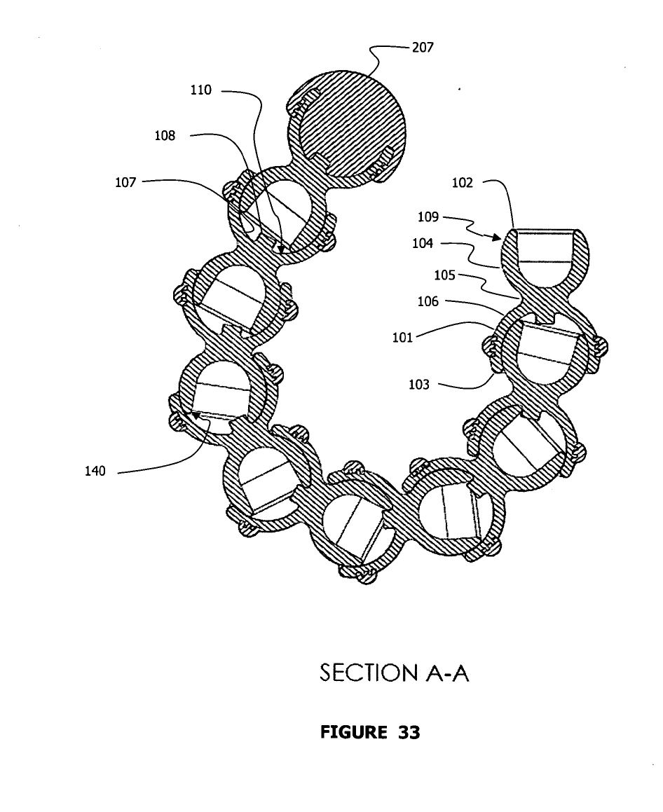

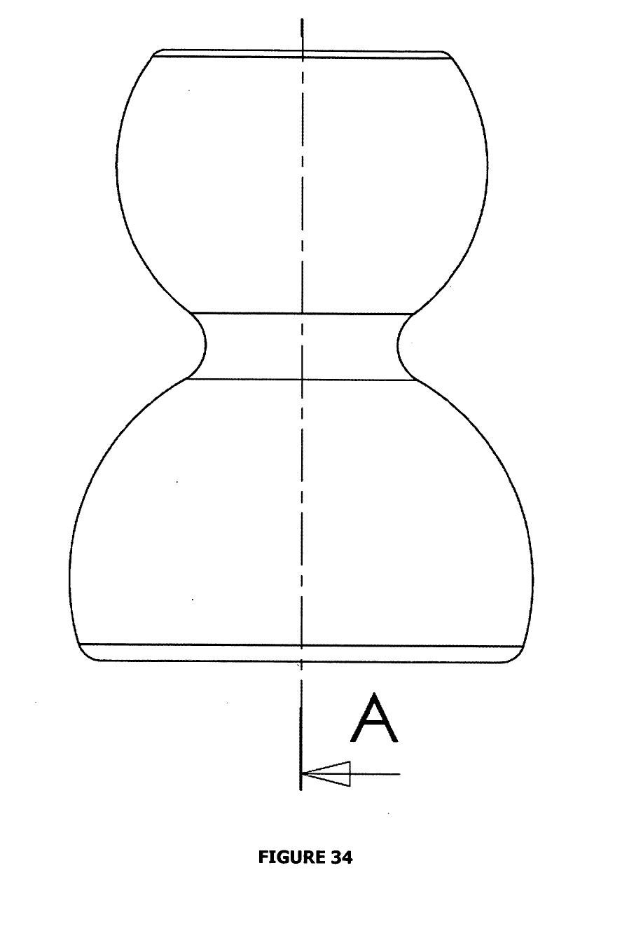

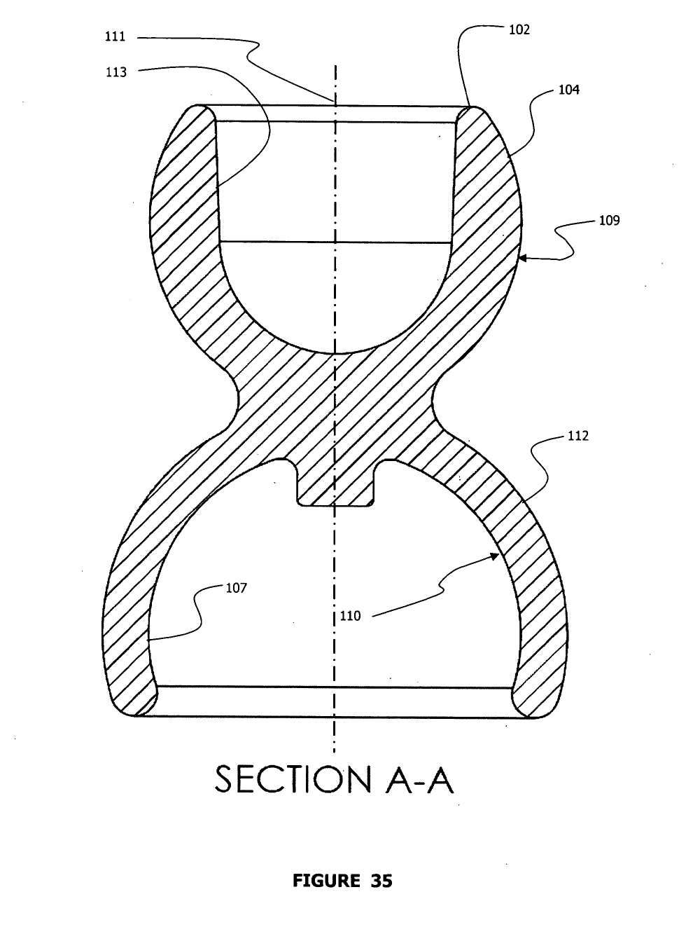

FIG. 33 illustrates a cross-sectional view of a plurality of ball and socket joint connectors. In some embodiments of the present invention, a stop nub 108 resides within the internal socket receiving cavity. The inner rim 140 of the socket engaging end surface 104 is adapted to contact the stop nub 108 as the two connectors reach a certain angle relative to each other. The contact of the stop nub 108 and the inner rim 140 of the socket engaging end surface 104 acts as a mechanical stop with regard to further angulation of the two pieces relative to each other. The mechanical stop function works to prevent over-rotation and possible disconnection of the two connectors.

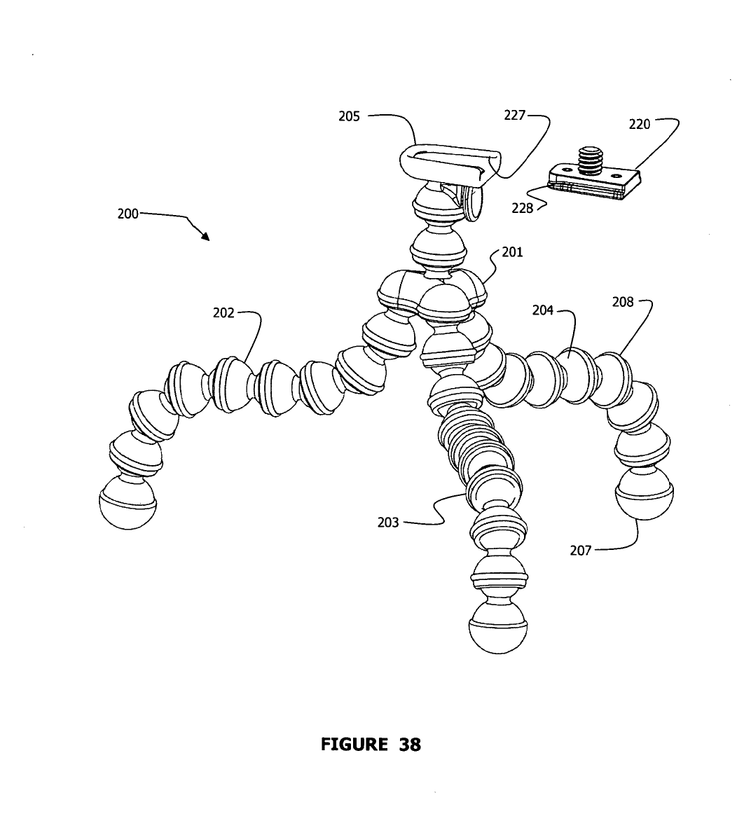

FIG. 38 illustrates a tripod apparatus 200 according to some embodiments of the present invention. A body portion 201 provides a base of support for three flexible legs 202, 203, 204. The flexible legs 202, 203, 204 consist of a series of interconnected ball and socket joint connectors. The flexible legs are able to be flexed into a variety of positions and can be used to support the body portion 201 by forming tripod support. The flexible legs are able to adapt to uneven surfaces to allow the tripod to function in a variety of situations. Although three legs are used here for illustration, more legs may be present in some embodiments. As seen, the body portion 201 itself may have a series of interconnected ball and socket joint connectors within it, allowing for even more flexibility with regard to its mounting function.

Although the flexible legs are illustrated as functioning legs, the legs are of sufficient flexibility that the may be used to wrap around items such as bars or other objects in order to fasten the tripod apparatus to objects that would not be suitable for mounting of a typical tripod. In conjunction with the gripping portion, this allows the tripod apparatus to be fastened to a variety of objects. For example, when used to position a digital camera, the legs may wrap around a vertical gate rail, allowing the mounting of the camera for a photo taking opportunity not previously available.

In some embodiments, the body portion 201 is connected to an interconnect portion 205. A clip 220 is removably fastened to the interconnect portion 205. The clip 220 may have a threaded post adapted to fit into a camera or other device in some embodiments.

In some embodiments, the flexible legs 202, 203, 204 may use connectors that have a co-molded gripping portion 208. The gripping portions 208 may allow for use of the tripod in a variety of ways, including wrapping of the legs around a post or other object. In some embodiments, the flexible legs may be terminated with a gripping pod 207. As seen in cross-section in FIG. 3, the gripping pod 207 may be fully molded into the cavity of the connector. In some embodiments, the terminal connector of each leg has a socket engaging end surface on its first end and a suction cup on its second end. The suctions cups may allow for a secure attachment of the tripod apparatus 200 to a variety of surfaces.

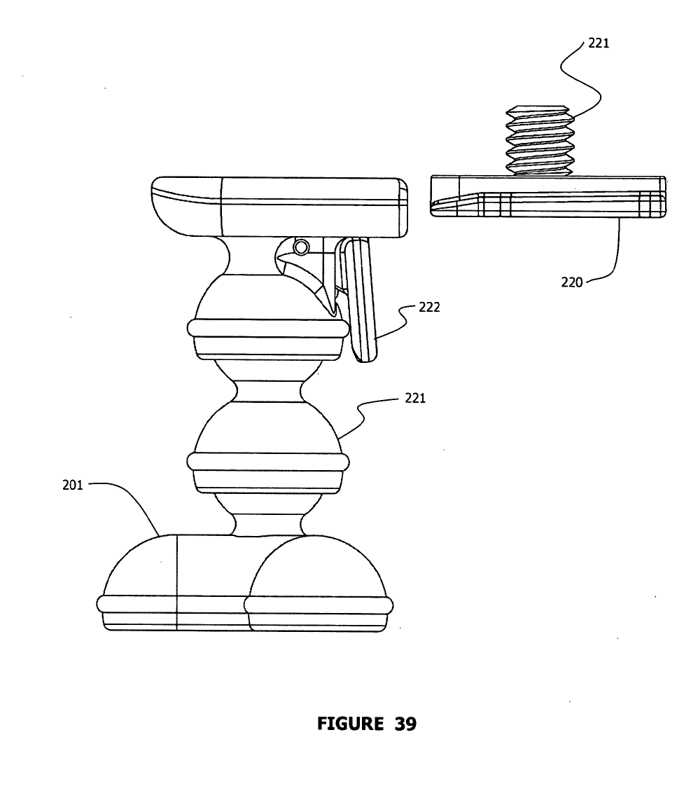

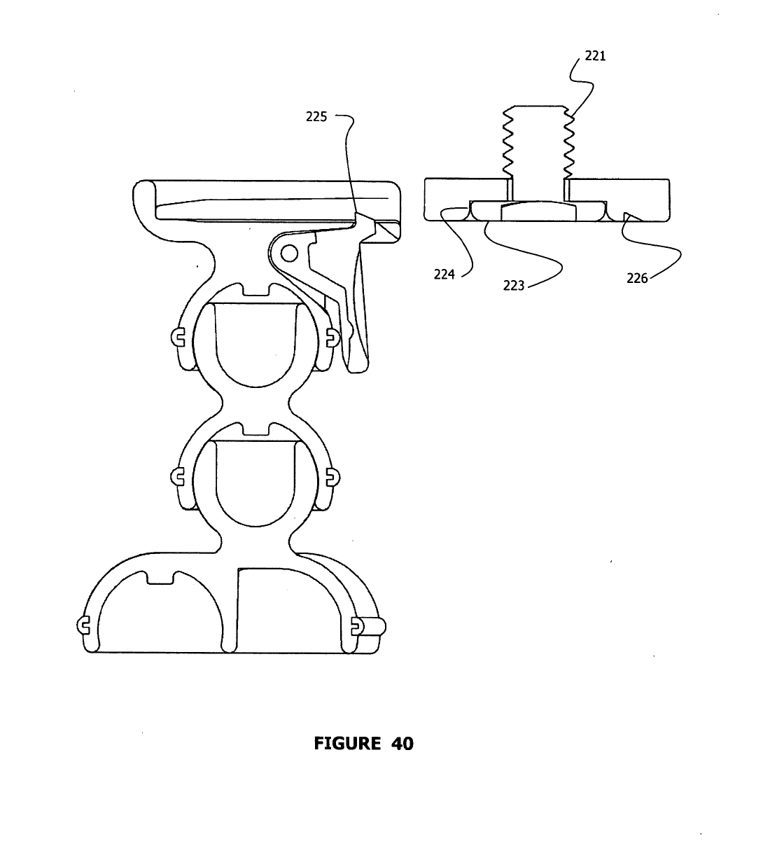

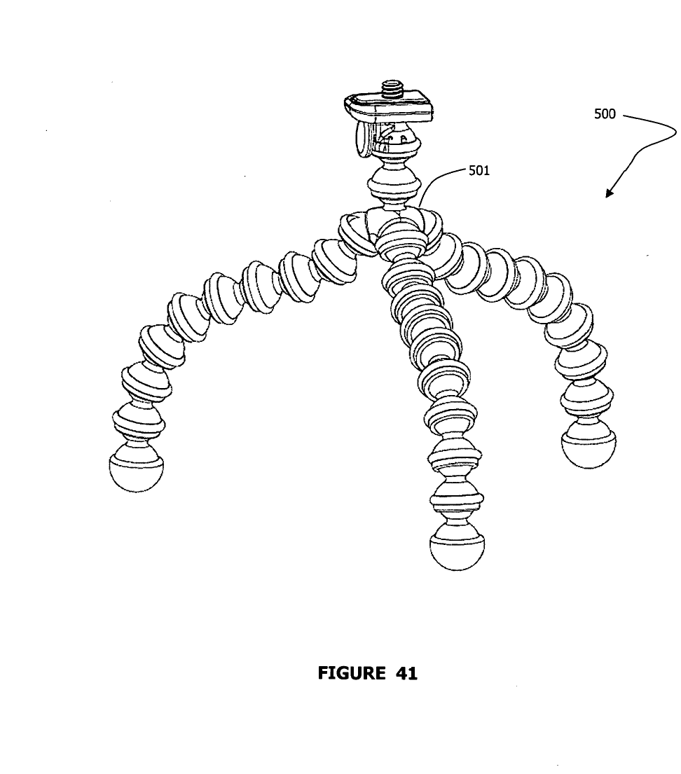

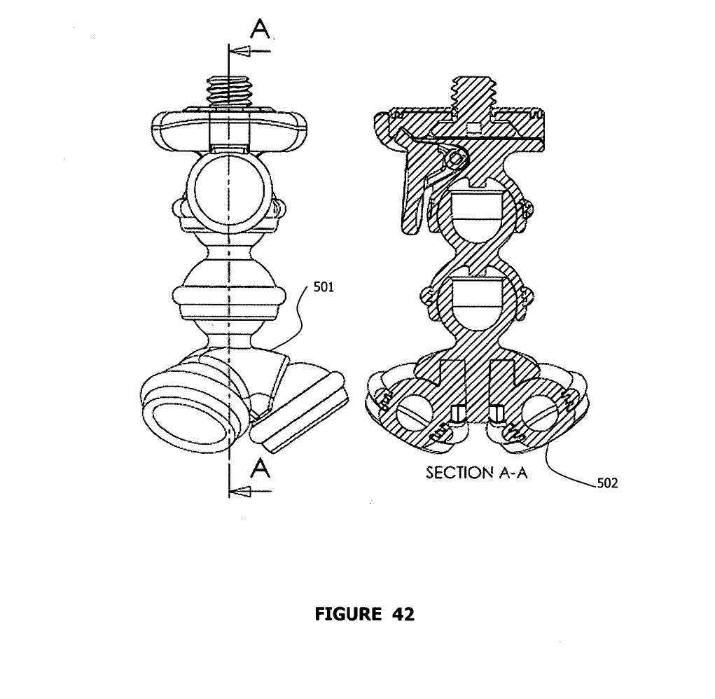

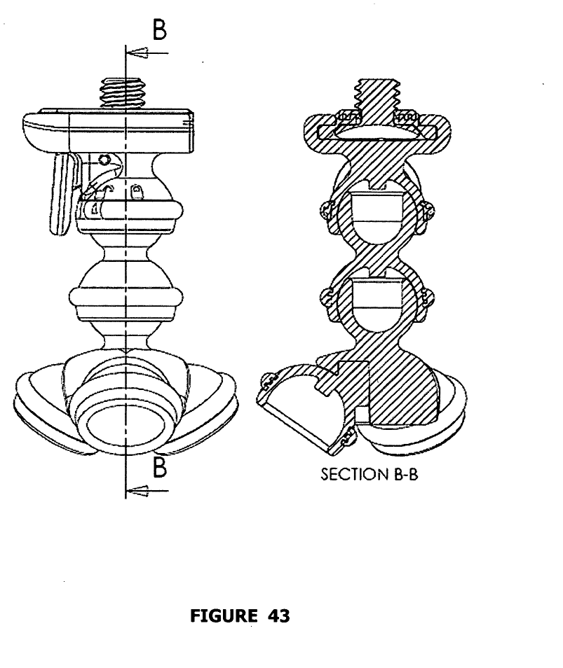

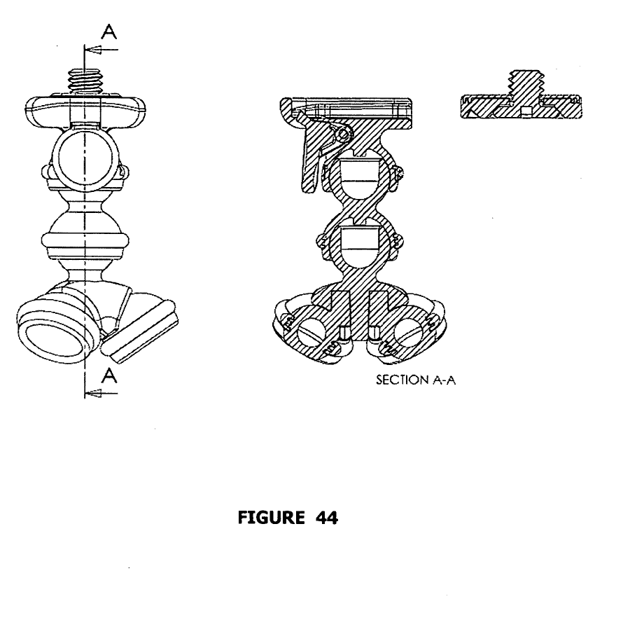

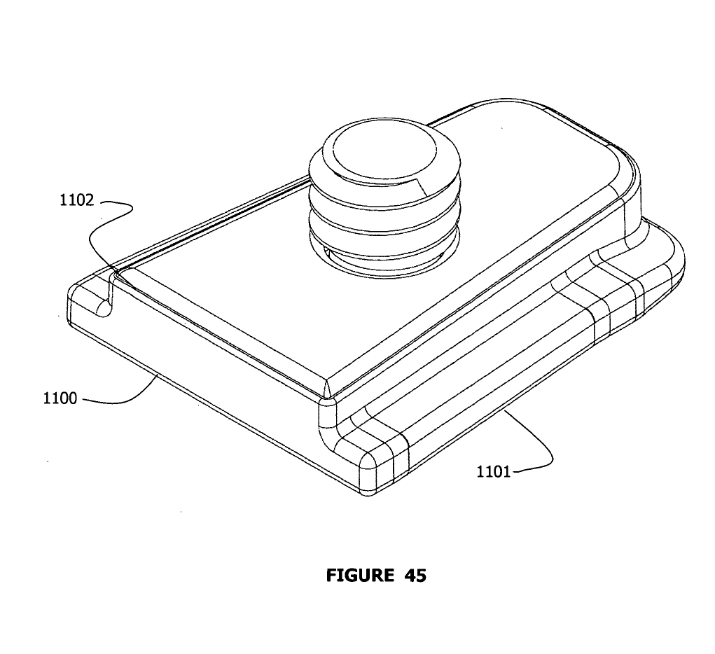

In some embodiments of the present invention, as further illustrated in FIGS. 39, 40 and 41, the interconnect portion 205 is adapted to receive a clip 220. The clip 220 may have rails 228 adapted to slide into slots 227 within the interconnect portion 205. The clip 220 may have recess 226 adapted to be filled by a tab 225 on a spring loaded lever 222. The clip is removably attached to the interconnect portion 205 and may be released by pressing on the lever 222. In some embodiments, the lever 222 is on the same side of the interconnect portion 205 as which the clip 220 slides in on. In other embodiments, the lever 222 is on the side opposite that which the clip 220 slides in on.

A mounting screw 221 may be recess mounted into the clip 220 in some embodiments. The screw 223 may be of the standard size and thread to attach to a camera in some embodiments. The head 223 of the screw 221 may be held into the recess 224 by a slight ridge in the molding of the recess in some embodiments.

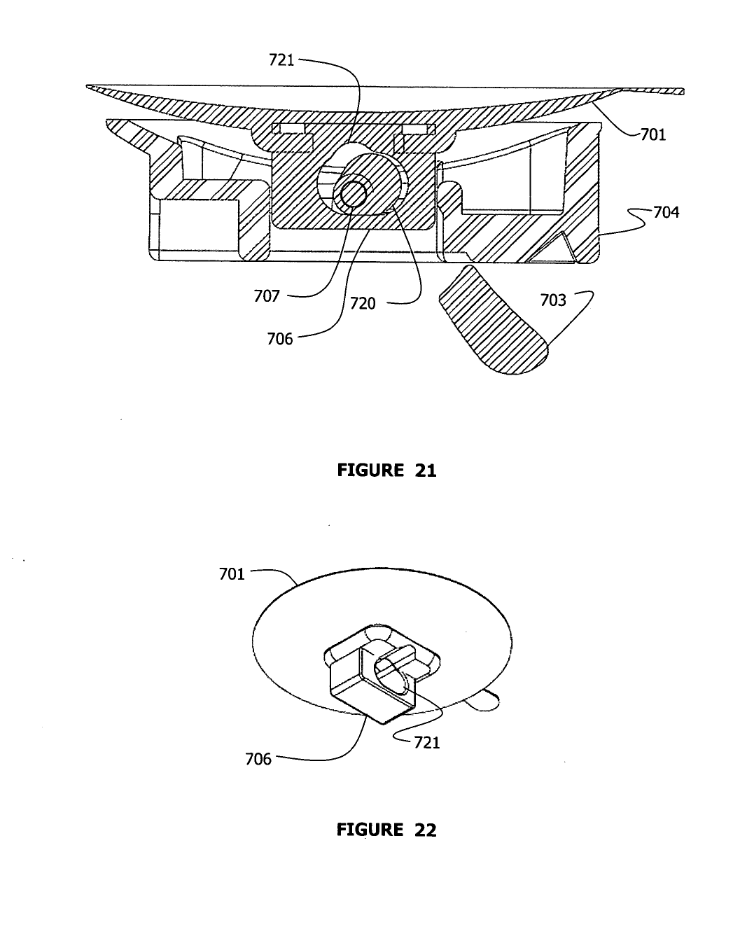

In some embodiments of the present invention, as seen in FIGS. 20, 21, 22, and 23, a tripod apparatus 500 utilizes a body portion 501 which spaces and locates the legs of the apparatus in a different configuration. The spacing of the body sockets 502 allows for better use of the tripod legs as attaching arms in some uses. In some embodiments, the body sockets 502 are equally spaced around the center of the body portion 501. The body sockets are also flared at an angle relative to the ground (in typical usage). In some embodiments, the flared angle is 45 degrees. The flaring of the body sockets allows a different range of potential wrapping angles for the legs of the tripod.

With the flaring of the body sockets, the tripod legs may still be utilized as in the case of a typical tripod. The range of motion of the body sockets and the connectors which form the legs still allow for vertical positioning of the legs. Thus, the body portion 501 retains the tripod's usual functionality. The flaring, however, allows for greater bending of the legs in cases where the legs are used as gripping arms, such as when wrapped around vertical bars and the like. Thus the body portion 501 adds to the range of positions and to the types of uses that the apparatus may entertain.

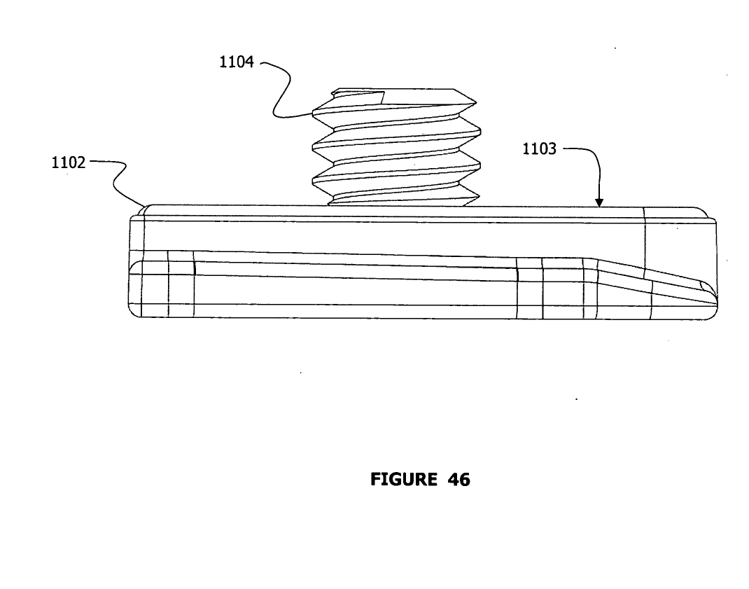

FIGS. 45 and 46 illustrate a clip according to some embodiments of the present invention. A clip 1100 is shown with a main body 1101 and a grip surface 1102. The clip 1100 is adapted to attach to a support structure such as a tripod. The clip 1100 may have a substantially flat bottom surface with a recess therein. The recess may be adapted to be filled by a tab which is adapted to be filled by a tab on a spring loaded lever.

When the clip is attached to an electronic device such as a camera, the threaded portion 1104 is threaded up into the device. This is done when the clip is not attached to the support structure, and allows for the clip to be attached to camera, or other device, just once, and from then on the clip may be clipped to the support structure without requiring repetitive threading into the device. The clip is small enough that it may be stored with the camera.

In some cases, there may be concern that the camera may rotate relative to the clip 1100 even after tightening of the threads up in to the camera. A grip surface 1102 allows for a grabbier surface 1103 to be in contact with the device or camera. The grip surface 1102 may be overmolded onto the main body 1101 in some embodiments. The grip surface 1102 may compress somewhat when the camera is threaded on to the clip. The grip surface may greatly reduce the likelihood of rotary movement of the camera relative to the clip.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A suction cup adapted to couple objects to rough surfaces, comprising:
a flexible sealing member having a continuous first surface adapted to be placed flush against an external rough surface such that a zero or low pressure region can be formed between the first surface and the external rough surface, wherein said external rough surface has a surface roughness Ra of about 2 microns or more;
a backing member embedded within or coupled to a second surface of said flexible sealing member opposite said first surface and adapted to pull a central portion of said sealing member away from said external rough surface to create said zero or low pressure region, thereby creating a suction hold against said external rough surface; and
a release mechanism adapted to diminish the suction hold against said external rough surface when said release mechanism is activated by a user.

2. The suction cup of claim 1, wherein said first surface is formed from a material having a durometer rating of less than about 50, shore A.

3. The suction cup of claim 2, wherein said first surface is formed from a material having a durometer rating of less than about 30, shore A.

4. The suction cup of claim 3, wherein said first surface is formed from a material having a durometer rating of less than about 10, shore A.

5. The suction cup of claim 1, wherein said first surface is formed from a low durometer rubber.

6. The suction cup of claim 1, wherein said external rough surface has a surface roughness Ra of about 5 microns or more.

7. The suction cup of claim 1, wherein said external rough surface has a surface roughness Ra of about 10 microns or more.

8. The suction cup of claim 1, further comprising:
a rigid outer shell disposed above said flexible sealing member and said backing member, wherein an outer circumference of said outer shell can be used to facilitate a seal between said flexible sealing member and said external rough surface, and wherein said outer shell houses at least a portion of said release mechanism.

9. The suction cup of claim 8, wherein said release mechanism comprises a button or lever adapted to push said backing member toward said external rough surface when said button or lever is activated by a user, thereby also pushing the central portion of said flexible sealing member toward said external rough surface.

10. The suction cup of claim 9, wherein said button or lever is also adapted to pull said backing member away from said external rough surface when said button or lever is activated by a user, thereby also pulling the central portion of said flexible sealing member away from said external rough surface.

11. The suction cup of claim 8, wherein said rigid outer shell comprises a clip mating portion integrated therein, said clip mating portion adapted to be inserted into a receiving portion of an associated clip.

12. The suction cup of claim 1, wherein said backing member comprises one or more openings situated therein, whereby portions of said flexible sealing member are sucked into said one or more openings when said zero or low pressure region is created between said flexible sealing member and said external rough surface.

13. The suction cup of claim 12, wherein said backing member comprises a plurality of fingers connected at a central hub region and having openings therebetween.

14. A tripod adapted to support an object thereon, comprising:
a body portion;
a plurality of flexible legs, each of said flexible legs comprising a first end and a second end, said first end coupled to said body portion;
an interconnect portion coupled to said body portion;
a clip receiver coupled to said interconnect portion; and
a clip removably inserted into said clip receiver, said clip comprising a main body and a suction cup coupled to said main body, wherein said suction cup is adapted to support a rough surface of an object thereon.

15. The tripod of claim 14, wherein said suction cup comprises:
a flexible sealing member having a continuous first surface adapted to be placed flush against said rough surface such that a zero or low pressure region can be formed between the first surface and the rough surface, wherein said rough surface has a surface roughness Ra of about 2 microns or more;
a backing member coupled to a second surface of said flexible sealing member opposite said first surface and adapted to pull a central portion of said sealing member away from said rough surface to create said zero or low pressure region, thereby creating a suction hold against said rough surface; and
a release mechanism adapted to diminish the suction hold against said rough surface when said release mechanism is activated by a user.

16. The tripod of claim 14, wherein said second end of each of said flexible legs comprises a suction cup.

17. A suction cup adapted to couple objects to rough surfaces, comprising:
a flexible sealing member having a first surface adapted to be placed against an external rough surface such that a zero or low pressure region can be formed between the first surface and the external rough surface;
a backing member embedded within or coupled to a second surface of said flexible sealing member opposite said first surface and adapted to pull a central portion of said sealing member away from said external rough surface to create said zero or low pressure region, thereby creating a suction hold against said external rough surface, wherein the area of said sealing member central portion pulled by said backing member comprises at least 30 percent of the overall area of said flexible sealing member; and
a release mechanism adapted to diminish the suction hold against said external rough surface when said release mechanism is activated by a user.

18. The suction cup of claim 17, wherein said first surface is formed from a material having a durometer rating of less than about 50, shore A.

19. The suction cup of claim 17, wherein the area of said sealing member central portion pulled by said backing member comprises at least 50 percent of the overall area of said flexible sealing member.

20. The suction cup of claim 17, wherein said external rough surface has a surface roughness Ra of about 2 microns or more.
